(19) United States
(12) Patent Application Publication
(10) Pub. No.: US 2024/0208095 A1
(43) Pub. Date: Jun. 27, 2024

(54) Portable Cutting Device To Cut A Workpiece

(71) Applicant: Oren Benshimol, Brooklyn, NY (US)

(72) Inventor: Oren Benshimol, Brooklyn, NY (US)

(21) Appl. No.: 18/086,061

(22) Filed: Dec. 21, 2022

(51) Int. Cl. B26D 1/04; B26D 5/00; B26D 5/10; B26D 7/20; B26D 7/26

(52) U.S. Cl. CPC B26D 1/045; B26D 5/005; B26D 5/10; B26D 7/20; B26D 7/2621; B26D 7/2635

(57) ABSTRACT

A portable cutting device to cut a workpiece is provided for particular use with cutting sheetrock or drywall. More particularly, a portable cutting device having a portable workbench adapted for use with commonly used construction materials for ease of construction and ease of access to replacement parts.

### FIELD OF THE INVENTION

The field of the invention relates to portable cutting machines and cutting workbenches for construction sites.

### BACKGROUND OF THE INVENTION

The instant invention relates to portable cutting machines and cutting workbenches for use at construction sites. In particular, the instant invention provides an improved system and method for cutting sheetrock or drywall, and other materials at a construction site where bulky machines and workbenches are impractical, inefficient, and alternative methods of cutting sheetrock, drywall, and other materials are imprecise and can create unnecessary waste and hazards.

During the construction of a building—whether commercial or residential—sheetrock, drywall, and other materials are often delivered to a worksite uncut and provided in a format that is received from the producer of the material. A principal reason for this is that the actual dimensions of the installation area for the materials often vary from an architectural plan calling for the use of the materials. For example, a common dimension for stock sheetrock is ½″×4′×8′. Dimensions for stock sheetrock vary, however, and can include different thicknesses, such as ¼″, ⅜″, ½,″ and ⅝″. In addition, the length and width of drywall sheets are often provided in multiples of 4 feet, and most commonly, 4′×8′, 4′×10′, or 4′×12′ sheets. Typical sheets, regardless of size, are made from dry gypsum in their core, with 1 mm of paper laminated on the front and back of each sheet.

During construction, such stock materials may be delivered to an open-materials staging area. In many cases, the stock materials are preferably cut at the point of installation, and material installers will typically hand-cut the sheetrock following the measurement of the actual dimensions of the installation area. Accordingly, a common method of preparing materials, such as drywall, is to first-hand measure or utilize a laser-guided measure device at the actual installation area to determine the dimensions of the actual installation area within the dimension of the stock material to fit the installation plan.

When arriving on a job site, the sheets are usually stacked flat on the floor. The installer will draw the measurements on the sheetrock with a marking tool and then run a utility knife on the marking. The utility knife has to perform a cut that is deeper than 1 mm, but no more than 2 mm. This cut is only to score the 1 mm paper layer on the front of the sheet. The installer has to pick up the sheet and flip it from the front side to face down. The sheet has to be folded along the opposite side of the cut in order to snap the gypsum material in the core of the sheet. The installer has to cut the 1 mm paper on the back of the sheet with the utility knife to achieve the final separation of the cut piece.

Unfortunately, hand-cutting material—such as cutting sheetrock by hand with a drywall knife—is often imprecise and inaccurate, and can lead to wasted time, wasted materials, and injury. In addition, in the case of sheetrock, hand-cutting also requires that the material is flipped or reversed in order to score or cut the opposing side. This practice can result in broken and wasted material, as well as injury, among other things. In many cases, material installers may attempt to hand-cut material such as sheetrock on the floor of the work area.

A number of solutions have been proposed utilizing cutting systems, but none of which provide the benefits of the instant invention.

In U.S. Pat. No. 9,089,985, titled “sheet cutting device,” a device is provided having a moving mechanism configured to move a cutting edge of a movable blade away from a cutting edge of a fixed blade in a manner that is intended to prevent a sheet that is being cut from being curled up and jammed by being hooked on the movable blade. The solution may have benefits for materials such as paper but does not provide the benefits of the instant invention for use with sheetrock or drywall, among other materials.

In European patent EP 3962686, entitled “portable automated panel cutter,” a device is provided having a plurality of frame profiles releasably connected to form a support frame, and a carriage releasably mounted comprising a tool-holder carriage movable with a power cutter that is releasably mounted thereto. This device permits a three-dimensional bidirectional cutting mechanism and provides an overly complicated solution to what should be a simple and efficient device for a simple linear cutting direction in one direction. It requires a powered cutting tool which is inapplicable to many situations requiring a portable device where the installation area may not yet have power. In addition, the solution proposed by the European device requires a complicated guide mechanism for carriage of the powered cutting tool, thereby requiring greater mass and thus entails a heavier weighted mechanism which almost eliminates its use as a portable cutting device. In addition, it requires specially adapted cutting tools for operation with sophisticated electronic control mechanisms.

Similarly, in U.S. Pat. No. 7,779,737 entitled “multi-axis panel saw,” a similar solution is proposed having two cutting blades, one blade for cutting material on the first axis and a second blade for cutting material on a second axis. The panel saw provides for repeated cross-cuts and rip cuts without changing the cutting location of the first cutting blade. While the mechanisms in the solution are simpler than the European patent, this is also a more sophisticated solution than is necessary. It also appears intended for a static or installed cutting mechanism, not a portable device.

Other solutions are likewise designed for particular purposes and materials. For example, in CN 107972187, described as a “movable type stone cutting machine,” a device is described as a movable type stone cutting machine with a rack body having a linear guide rail in a longitudinal direction. In this case, it is the workbench that is pushed and pulled to slide along a guide rail and not the material itself that is pushed or pulled through a cutting aperture. The solution certainly has been used for heavy materials such as stone but is not applicable use with materials such as sheetrock or drywall.

Accordingly, there is a need for a solution to the above-identified problems that existing systems and methods have yet to address adequately and to provide a solution that the marketplace has yet to present.

### SUMMARY OF THE INVENTION

The instant invention relates to a portable cutting device to cut a workpiece. In particular, a preferred embodiment provides a portable cutting device for cutting sheetrock at construction or other worksites, which can be assembled from a number of components, including a main cutter housing, an upper cutting apparatus, a bottom cutting apparatus, a cutting apparatus controller, a left side bed, a right side bed, and a back side bed.

The main cutter housing is preferably pre-assembled with its components, including a first horizontal track, a second horizontal track, a right-side vertical track, a left-side vertical track, and a workpiece aperture. The upper horizontal track is attached to the top side of the main cutter housing and is movably connected to a top end of the right-side vertical track and includes an upper cutting apparatus. Accordingly, the cutting apparatus is able to move along said first track. A bottom horizontal track is also provided and attached to the bottom side of the main cutter housing, is movably connected to the bottom end of the right-side vertical track, and includes a bottom cutting apparatus. Accordingly, the second cutting apparatus is able to move along the second horizontal track. Both the upper horizontal track and bottom horizontal track are parallel to one another and positioned such that the upper cutting apparatus and said bottom cutting apparatus are able to contact and cut the workpiece as the cutting apparatus is moved across the aperture and makes the cut along the workpiece.

Different variations of the invention are provided herein, including providing a removable drywall cutting blade or a removable circular cutting blade for the cutting apparatus.

It is to be understood that both the preceding description and the following description are exemplary and explanatory only and are not restrictive of the invention, as claimed. Specific examples are included in the following description for purposes of clarity, but various details can be changed within the scope of the present invention.

### BRIEF DESCRIPTION OF THE DRAWINGS

A preferred embodiment of the invention has been chosen for detailed description to enable those having ordinary skill in the art to which the invention appertains to readily understand how to construct and use the invention and is shown in the accompanying drawing in which:

FIG. 1 illustrates a preferred embodiment of the invention from a perspective view in an assembled state.

FIG. 2 illustrates a main cutter housing portion of an embodiment of the invention from a perspective side view.

FIG. 3 illustrates a right portion of an embodiment of the invention showing internal mechanisms.

FIG. 4a shows a top view of a portion of an embodiment of the chain driver housing in accordance with the invention.

FIG. 4b shows a cross-section view of a portion of an embodiment of the chain driver housing in accordance with the invention.

FIG. 4c shows a to view of a portion of an embodiment of the chain driver housing in accordance with the invention.

FIG. 4d shows a cross-section side view of a portion of an embodiment of the chain driver housing in accordance with the invention.

FIG. 5 shows a top view of portions of an embodiment of the invention, including the chain or traveler drivers and cutting apparatus.

FIG. 6 shows a perspective view of portions of an embodiment of the invention, including the chain or traveler drivers and cutting apparatus moving gearbox.

FIG. 7 shows a side view of an embodiment of the invention, including a gearbox arrangement relative to the prime mover, not to scale.

FIG. 8 shows a side view of an embodiment of the invention, including a secondary mover and/or thickness adjustment setting for two embodiments.

FIGS. 9a and 9b show a front and side view of alternative embodiments of the cutting apparatus according to the invention.

FIGS. 10a and 10b show a front and side view of alternative embodiments of the cutting apparatus according to the invention.

FIG. 11 shows a front view of a portion of an embodiment the invention showing the cutting apparatus and horizontal tracks.

FIG. 12 shows a front view of a portion of an alternative embodiment the invention showing the cutting apparatus and horizontal tracks.

FIG. 13a shows a front view of a portion of the cutting apparatus and horizontal track.

FIG. 13b shows a front view of a portion of the cutting apparatus base and block.

FIG. 14 shows a side cutaway view of a portion of an alternative embodiment of the invention with a workpiece, where each cutting apparatus is in an engaged cutting position.

FIG. 15 shows a perspective view of an alternative embodiment of the invention in an assembled state.

FIG. 16 shows a portion of remote control and data system of an alternative embodiment of the invention in an assembled state.

FIGS. 17a and 17b shows a side view and front view of an alternative embodiment a cutting apparatus according to the invention.

The representations of a preferred embodiment and alternative embodiments of the invention are provided for illustrative purposes only and are not to scale.

### DETAILED DESCRIPTION OF THE INVENTION

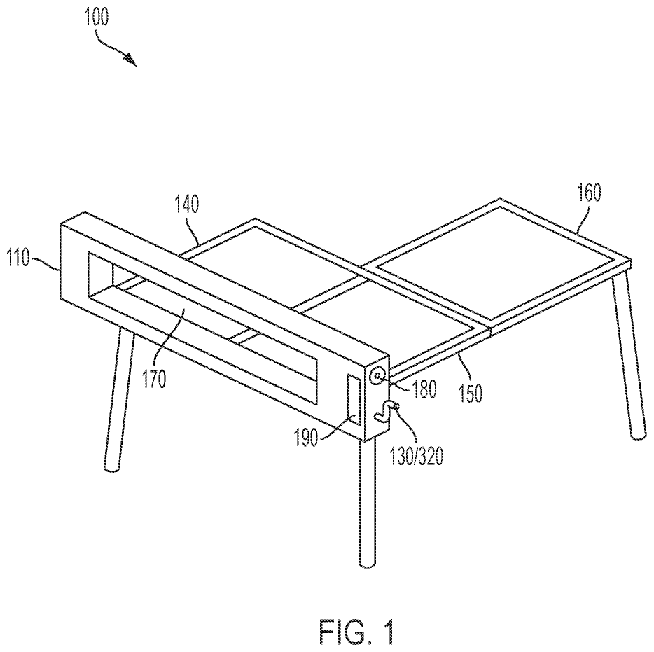

Referring to the drawing, FIG. 1 illustrates a preferred embodiment of a system according to the invention and shows the best mode disclosed herein. Specifically, a portable cutting device 100 is provided comprising a main cutter housing 110, a left side bed 140, a right side bed 150, a back side bed 160, at least one transverse cutting apparatus 120, a thickness adjustment 180, and a cutting apparatus controller 130. In a preferred embodiment, the thickness adjustment switch 180 is a mechanical dial, and the cutting controller 130 is a mechanical hand crank. The main cutter housing 110 is provided as a closed envelope to hold inside several of the principal components, described further below. More specifically, the main cutter housing 110 comprises a frame around a workpiece aperture 170. The workpiece aperture 170 runs through the main cutter housing 110 from a back side to a front side of the main cutter housing 110. The main cutter housing 110 can also include a service access panel 190, which is movably attached to the main cutter housing to allow an operator to access mechanisms within the main cutter housing, such as the cutting apparatus blades. The terms “Upper,” “Bottom,” “Left,” “Right,” “Horizontal,” and “Vertical,” as may be used herein, are used for relative orientation in relation to the workpiece in the middle of the main cutter housing.

The main cutter housing 110 is removably connected to a left-side bed 140 and a right-side bed 150 at the bottom edge of the backside of the main cutter housing 110. The left side bed 140 and right side bed 150 can be connected at a side of the left side bed 140 and right side 150 where the two beds meet. In addition, a back side bed 160 is provided connected to the right side bed 150. In one embodiment, the left side bed, right side bed, and back side bed are provided as surfaces, such as wooden plane boards to provide a table upon which the workpiece may rest, be measured, and moved toward the headframe or cutter housing 110 for cutting. In addition, the dimensions of the left side bed, right side bed, and back side bed can be made to fit the maximum dimension of the intended workpiece. For example, each left side bed and right side bed can be three-foot deep by 4½ feet wide, and the back side bed can likewise be an added three-foot deep length for long workpieces.

Each left-side bed 140, right-side bed 150, and back-side bed 160 can be provided with one or more leg supports and together comprise a table for the operator to work comfortably above the surface of the work area. Thereby, a workpiece, such as sheetrock or drywall, can be placed on the table and moved through the workpiece aperture 170 to a position where the workpiece can be cut. The bed and leg supports can be fabricated from lightweight aluminum or wood, among other things. The main cutter housing is preferably made from stainless steel. Unless otherwise indicated, component parts can be fabricated from either stainless steel or aluminum, as can be appreciated by a person of ordinary skill in the art to provide a trade-off between strength, durability, and weight.

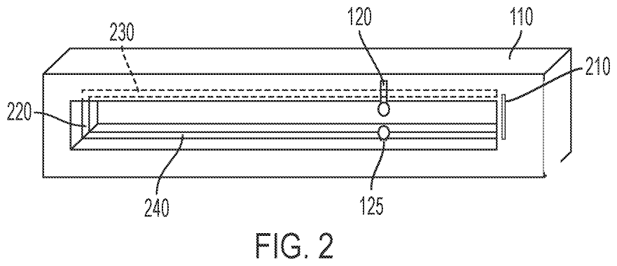

More particularly, as shown in FIG. 2, the main cutter housing 110 can be formed as a rectangular hollow box with a narrow rectangular aperture running lengthwise and is preferably fabricated from stainless steel or reinforced aluminum. In a preferred embodiment, the workpiece aperture 170 is at least 8′ wide and at least 1″ high.

As shown symbolized in FIG. 2, and not to scale, the main cutter housing 110 includes a right-side vertical track 210 and a left-side vertical track 220, which run parallel to each other on either end of the main cutter housing 110, and within the aperture 170. In a preferred embodiment, the vertical tracks 210, 220 are provided as vertical U-channel or C-channels within an inside portion of the head frame of the main cutter housing at a left and right side of the aperture 170. The bottom and top of these channels 210, 220 are connected to the Main Cutter Housing (MCH) with brackets or provided as U-channel or C-channels that are integrally formed from the material of the envelope from which the main cutter housing is fabricated.

Furthermore, as symbolized in FIG. 2, not to scale, the left and right-side vertical tracks movably support an upper horizontal track 230 (or top track) at a top portion of the aperture 170 and. A bottom horizontal track 240 (or bottom track) is also provided and movably supported by the vertical tracks at a bottom portion of the aperture. The horizontal tracks 230, 240 are disposed parallel to each other, one on the top side of the workpiece aperture 170, and one on a bottom side.

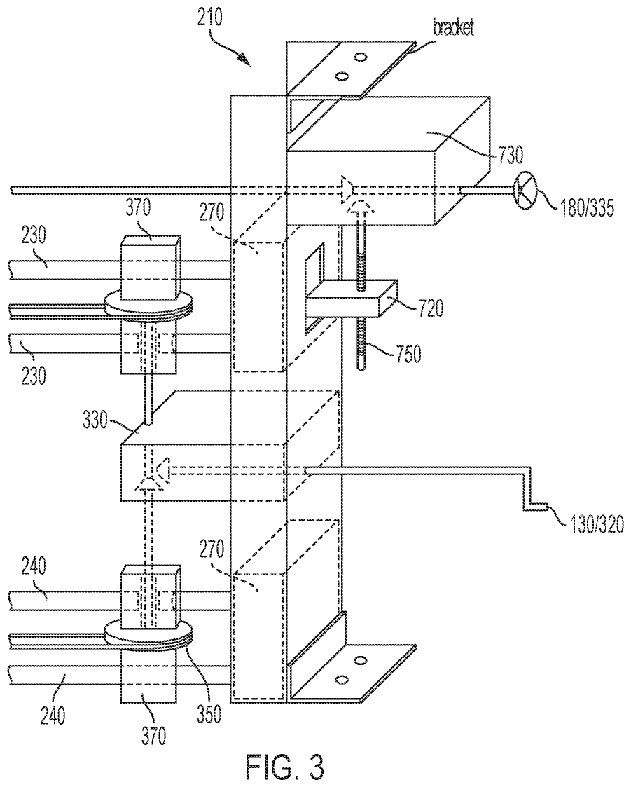

FIG. 3 shows a right-side portion of an embodiment according to the invention. An upper horizontal track 230 is provided, comprising two smooth rods, which are installed in tandem/parallel and which span the aperture 170. The horizontal track 230 is connected to the right-side vertical track by a base such as a saddle block 270 that is vertically movable within the U-shaped vertical track 210. Track 230 is supported on either end by a saddle block 270, one on the right side of the vertical track as shown in FIG. 3, and one on the left side of track 230 (not shown). Each saddle block is movably disposed within left and right vertical track 210/220. In a preferred embodiment, both the left and right side saddle blocks include a threaded bore that connects with a depth-adjusting gearbox 730, as described further within.

A bottom horizontal track 240 is provided, comprising a mirrored set of components of the top track with the exception that the saddle block is fixed in a stationary position within the U-shaped vertical track 210.

The right-side vertical track 210 is provided as a U-shaped vertical track which can be formed from sheet metal in a U-shape or preferably from forged steel having U or C channels, to have minimum wear and tear. The vertical track 210 is attached to the main housing unit 110 (not shown) with one or more brackets at either end. A duplicate set of the above structures are provided with a left-side vertical track (not shown) and are disposed mirrored on the left-side portion of the embodiment of the invention.

A vertical displacement of the upper horizontal track 230 can be provided by a vertical movement along the left and right-side vertical tracks by moving the saddle block with an adjustment mechanism 180. It is intended that a vertical adjustment is made once and prior to the beginning of a cut of an intended workpiece. A thickness adjustment setting 180 is provided for adjusting the vertical distance of the upper horizontal track 230, and is operatively connected to the vertical track and saddle block 270 by a secondary driveshaft system 335.

A chain driver 370 is provided for each upper and lower track to move the cutting apparatus (not shown) transverse direction. The chain drivers are powered by a prime mover and controlled by a cutting apparatus controller 130, which are described further below.

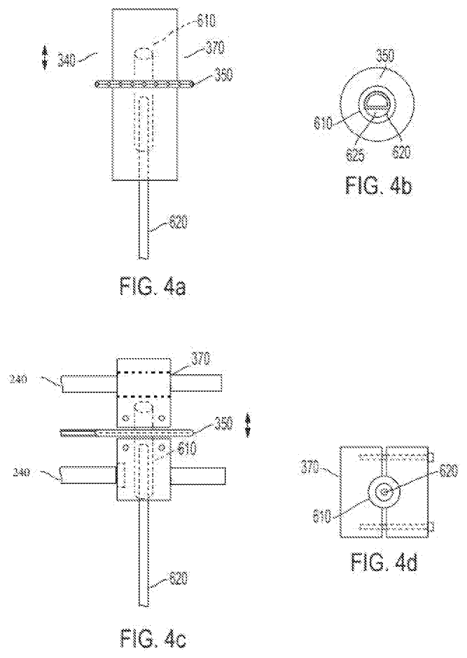

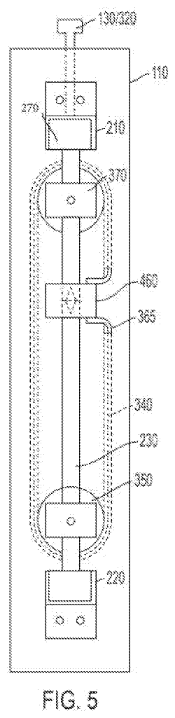

FIGS. 4 and 5 show greater detail of the chain driver 370. As shown in FIGS. 4a, 4b, 4c, and 4d, a chain driver 370 is provided comprising two halves of chain block 340 to latch on the upper horizontal track and bottom horizontal track at the right side and the left side. Each half of the block has half a bore in it, and once the two halves of the block are fastened around the upper horizontal track (or bottom horizontal track), the block forms a complete bore.

In addition, the chain driver 370 includes a prime mover driveshaft 620, which runs through one of the blocks on one side of the chain driver 370. Chain block 340 is disposed around a teethed cog 350 at one end of the main cutter housing 110. The teethed cog 350 can be a gear, flywheel, or other devices, that, when rotated on its axis, can pull the driving connection back and forth along the width of the workpiece aperture 170. The teethed cog 350 is rotatably supported by a traveler driveshaft 620. The chain driver 370 is movably connected to block 340 that can be seated within or connected to a right-side vertical track 210 disposed within the main cutter housing 110 at a (right) side of the workpiece aperture 170.

More specifically, FIG. 4 shows detail of a chain driver (or traveler) housing 370 portion of the device, and mechanisms for vertical movement of the chain driver, to move the teethed cog 350 while providing transmission of movement from the prime mover 320 as shown in FIG. 4. The teethed cog 350 is rotatably movable and driven by a traveler gear sleeve 610 connected at its axis, which is rotatably supported by the chain driver housing 370, such as by a cylindrical aperture provided in the housing. The traveler gear sleeve 610 is movably connected to a traveler driveshaft 620 along a length of the gear sleeve 610. The traveler gear sleeve 610 is provided with a smooth bore hole through its center axis, which the traveler driveshaft 620 can move back and forth through the borehole. As shown in FIG. 4b, the traveler driveshaft 620 is provided with a portion keyed 625 with the traveler gear sleeve 610 in an axial direction, such as providing the traveler driveshaft 620 with a flat face at one side of its radial profile and providing the traveler gear sleeve 610 with a cooperating face or key at a further keyed portion 625 of its borehole. Accordingly, the traveler driveshaft 620, when rotated and driven by the prime mover, can drive the traveler gear sleeve 610 even as the sleeve moves along a length of the driveshaft 620. In addition, or in the alternative, the shaft connecting to the bottom of the upper chain driver can be provided with a notch along its length. This notch sits inside the center of the upper chain driver, allowing for the upper chain driver to go up and down as the shaft still stays inside. The notch 625 is the point of contact to spin the upper chain driver. Preventing the shaft from spinning ‘empty.’

In other words, the separate shaft going into the D shape portion of the bore 610 has a longitude straight face 625 to key the straight face in the corresponding cog shaft. This feature allows the upper horizontal track to go up and down without losing contact with the chain driver. Although the bottom horizontal track is set up the same, it does not need to use this feature, as it does not move up and down.

As shown in FIG. 5, the cutting carrier base 460 includes a driving chain connection 365 on either side, preferably at a midpoint between the two steel rods. Each of the driving chain connections 365 is connected to block 340, and horizontally lined up with cog 350 on either side at a midpoint thereof. The transverse linkage 340 can be a chain, band, belt, or other thin, flexible material. The driving chain connection 365 or bracket includes an offset bend 365 at the attachment of block 340 to the base 460 of one of the transverse cutting apparatus 120/125. The offset is provided to prevent interference with the cogs on the far ends of the tracks, which can be wider than the radius of the cutting apparatus. More specifically, the chain-driver cog is wider than the cutting apparatus. It can be appreciated by a person of ordinary skill in the art that a variety of different mechanisms can be provided to allow a cutting apparatus to traverse the aperture within the scope of the claimed invention as disclosed herein.

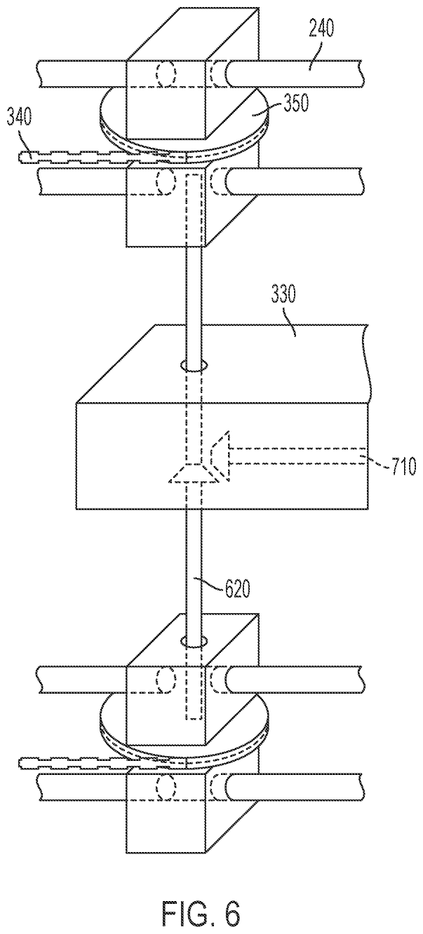

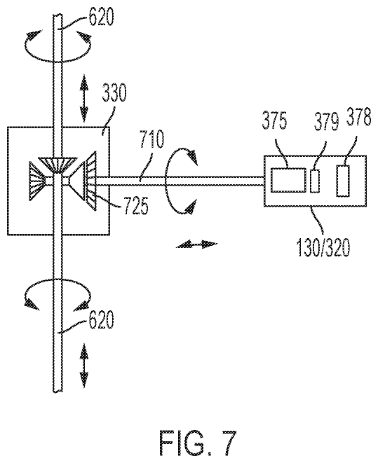

As shown in FIGS. 6 and 7, the cutting apparatus moving gearbox 330 provides transmission of power from the prime mover to each of the teethed cogs 350 via several cooperating gears and driveshafts. It can be appreciated by a person of ordinary skill in the art that the gearboxes can be adapted to provide the appropriate right torque and speed on the chosen gears. The cutting apparatus moving gearbox 330 is preferably disposed within or on the main cutter housing 110.

Specifically, the prime mover drives a prime mover driveshaft 710 to drive a transmission gear 725, which can be disposed orthogonal to a gear attached to the traveler driveshaft 620. The prime mover 320 can be a purely mechanical device, such as a hand crank, or can be an electromechanical system 320 comprising a motor 375 and one or more gears. It can be appreciated by a person of ordinary skill in the art that one or more gears may be provided for gear reduction to allow a higher rotation rate of the motor to be reduced and thereby transmit greater torque if necessary. Accordingly, the prime mover is operatively connected to the cutting apparatus controller 130, which can comprise an electric or electronic system 378, such as a switch for controlling the power and speed of the prime mover 320. The prime mover 320 can be adapted for reverse movement whereby in the part engagement of the switch, power is provided to the prime mover 320, which allows the system to move a cutting apparatus across the aperture from a starting position 1601 to an end position 1602. After that, a further switch can be provided for a reverse motion of the cutting apparatus back from the end position to a starting position. The electric motor and electronic controller 378 can be provided integrated within the main cutter housing or provided in a separate cutting apparatus moving gearbox 330.

In a preferred embodiment, once the cutting apparatus controller is engaged to begin the cutting operation, the prime mover through the series of mechanical connections, traverses or moves the upper cutting apparatus and bottom cutting apparatus simultaneously across the aperture in the horizontal direction, thereby allowing the cutting blades to cut the top and bottom portion of a workpiece simultaneously. A benefit of doing so simultaneously is to prevent damage to and potential breaking of the cutting apparatus.

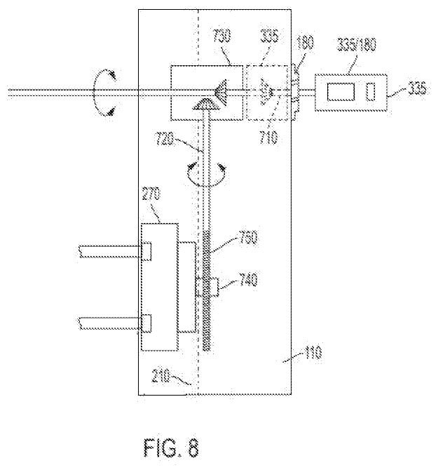

As shown in FIG. 8, a depth adjusting gearbox 730 is provided, having components for permitting a user to adjust the distance of the cutting instruments to accommodate different thicknesses of workpieces. A thickness adjustment setting 180 is provided, preferably a dial, that is mechanically connected to the vertical track by a series of gears with notch divisions for each setting, as can be appreciated by a person of ordinary skill in the art. A dial is preferable as it provides a simple device with tactile and visual confirmation for the user. Alternatively, the thickness adjustment setting 180 is an electromechanical device 335, as would be known by a person of ordinary skill in the art, operatively connected to a dial or switch, which provides a user with visual confirmation of the vertical displacement setting. The depth-adjusting gearbox provides transmission of power from the secondary mover 335 to the secondary traveler connection 740 of each chain driver 370. More specifically, in a first embodiment, the secondary mover 335 is mechanical and comprises a dial 180 for selecting the desired depth of the cutting instrument. The secondary mover 335 drives a secondary mover driveshaft 710, which has a gear disposed at a point orthogonal to a gear disposed at the end of a secondary traveler driveshaft 720. The secondary traveler driveshaft portion 740 can be a smooth rod having a first threaded portion 750 for vertical adjustment of the block 270. While block 270 is shown in FIG. 8 as having three portions, including connection 740, it can be appreciated by a person of ordinary skill in the art that block 270 and connection 740 can be formed as one or more structures.

Similarly, as to what was described above with respect to the prime mover driveshaft, it can be appreciated by a person of ordinary skill in the art that the secondary traveler driveshaft should also be parallel to the vertical track so that the traveler that is supported by the vertical track move freely up and down in a vertical direction.

The vertical displacement setting 180 is associated with varying widths of workpieces that the device can accommodate, such as ¼ inch, ⅜ inch, ½ inch, and ⅝ inch, among other things. It can be appreciated that the vertical setting 180 can be adapted for metric settings. The thickness adjustment setting 180 can be adapted to adjust the distance of the first cutting apparatus 120 and thereby select a thickness appropriate for the workpiece, and should also allow for 1˜2 mm extra lower to make sure it scores the paper on the top of the sheet. For example, if a ⅝″ sheetrock is selected, the blade will be ready to cut at 1/16″ less of that, which is 9/16″.

It is intended that the workpiece to be cut is initially placed between the horizontal tracks at their maximum opening distance, whereafter, the upper track can be adjusted in the vertical direction towards the workpiece to provide an appropriate cutting distance and pressure of the cutting instrument to the workpiece.

A cutting apparatus controller 130 is provided and operatively connected to the prime mover 320. The controller 130 is adapted to control the amount of mechanical motion that the prime mover transmits to the upper cutting apparatus 120 and bottom cutting apparatus 125 and move each apparatus 120/125 from a starting position across the aperture and provide the return of each cutting apparatus 120/125 back to the starting position. This is done by a series of mechanical and/or electromechanical devices described further below.

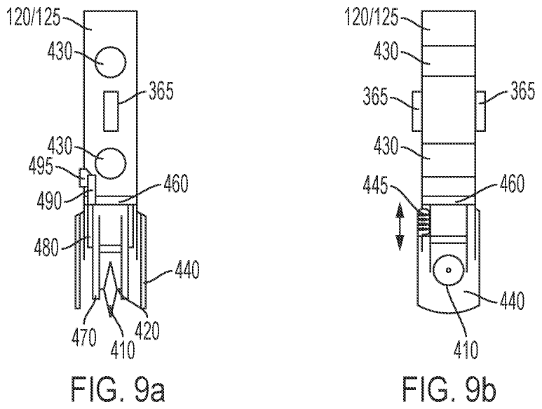

FIGS. 9a and 9b show greater detail of two embodiments of an upper cutting apparatus 120 and a bottom cutting apparatus 125 (as an inverted version FIGS. 9a, and 9b) according to the invention. FIG. 9a shows a front/back view of an embodiment of the transverse cutting apparatus, which can be alternatively used for a first (top) or second (bottom) transverse cutting apparatus. It is intended throughout the disclosure that the device is employed to utilize a plurality of interchangeable cutting instruments types for ease of replacement at a job site. For a nonlimiting example, straight edge drywall blades can be interchanged with circular blades, among other things. It can be appreciated by person of ordinary skill in the art that additional cutting instruments can be utilized for different circumstances and different types of workpieces.

Specifically, the transverse cutting apparatus 120/125 includes a removable cutting device 410 operatively connected to a base portion of the cutting apparatus base 460. Each upper cutting apparatus 120 and lower cutting apparatus 125 substantially mirror images of each other. In a preferred embodiment according to the invention, the removable cutting device 410 is a round disc blade, having a sharp edge around its perimeter for cutting a paper or paper material surface of a workpiece such as sheetrock. The removable cutting device is removably attached to a cutting pin pivot 420, which permits the round disc blade to rotate freely. The cutting pin pivot 420 is itself removably connected to a cutting carrier housing 470, which supports the cutting pin and is movably connected to a cutting carrier base 460. The cutting carrier housing 470 can include two struts or side plates which support the cutting pin pivot and round disc blade and is supported in a housing sleeve 480, movable in a vertical direction. The sleeve 480 surrounds and contains the cutting carrier housing 470, movably disposed within, and includes a compression spring 445, which is operatively connected to the cutting carrier base 460. The compression spring 445 provides vertical movement of the protective shroud when the cutting apparatus is engaged during cutting. The shroud 440 has rounded edges at its bottom portion in order to allow the shroud to move once it contacts the workpiece, as the cutting apparatus 120/125 traverses the aperture from the starting position and allows the cutting blade to contact the workpiece.

A housing adjustment and removal screw 490 is provided and preferably disposed at an outside face and parallel with the cutting surface, which slidably connects the housing 470 to the base 460 in a vertical direction. The adjustment and removal screw 490 includes a threaded screw portion and a cylindrical travel portion. The adjustment and removal screw 490 are removable for disconnecting the housing, round disc blade, and cutting pin for ease of replacement of the cutting device. In addition, the adjustment and removal screw 490 has a cylindrical travel portion for constraining the movement of the housing towards and away from the base 460. The adjustment and removal screw 490 can be screwed in or out, thereby setting a maximum distance of the travel of the housing vis-à-vis the base 460 and thereby providing the user with an adjustment of the compression strength of the compression spring 450, if used. An optional housing screw lock 495 can be provided for fixing the adjustment and removal screw 490 in a stationary position to prevent shifting of the screw 490 over the course of usage.

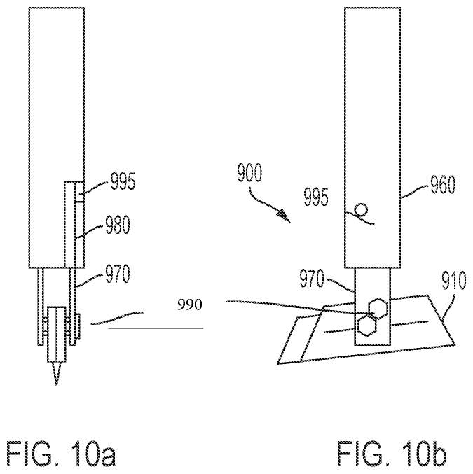

FIGS. 10a and 10b show an alternative embodiment of the invention, wherein the cutting blade 910 is provided as a replaceable straight razor or box cutter blade is an alternative to the round disc blade 410. The cutting blade 910, shown in FIG. 9, is represented as a trapezoidal device with a cutting edge. However, a number of blade variations can be used within the scope of the invention. In one embodiment, the cutting blade 910 is supported by the cutting carrier base 960 and/or a cutting carrier housing 970. Similar to the embodiment in FIG. 4, a removal screw 990 is provided for easy access and replacement of the blade.

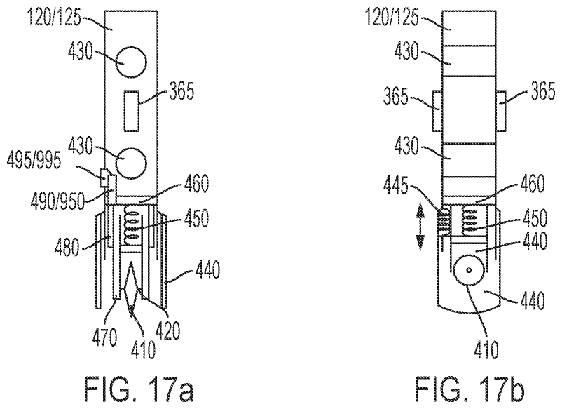

In a further alternative embodiment of a cutting apparatus according to the invention, a housing screw 995 can be provided for a user to adjust the compression resistance of a compression string 950 and the range of motion of the blade and housing within a housing sleeve 980 provided, as shown in FIGS. 17a and 17b.

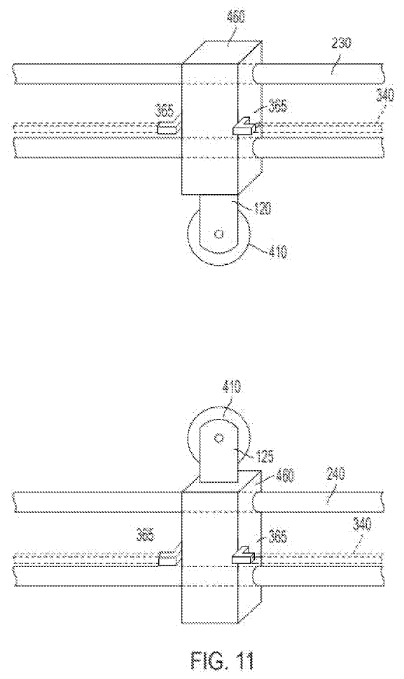

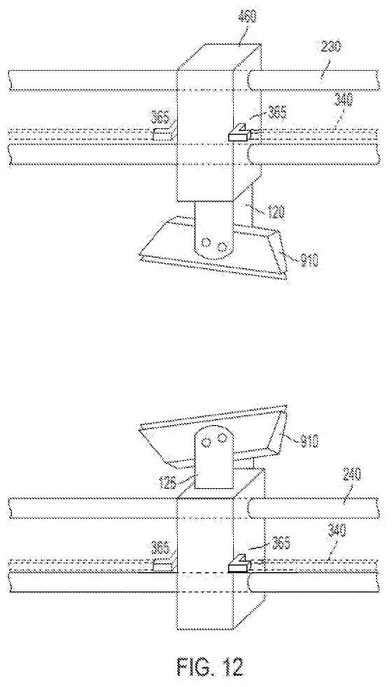

As shown in FIGS. 11 and 12 provide additional views for an upper cutting apparatus 120 which is movably connected to the upper horizontal track and within the workpiece aperture 170. A bottom-cutting apparatus 125 is also provided and movably connected to the bottom horizontal track and within the workpiece aperture 170. Both the upper cutting apparatus 120 and bottom cutting apparatus 125 run lengthwise along the first track 210 and second track 220, respectively, in coordination parallel to one another.

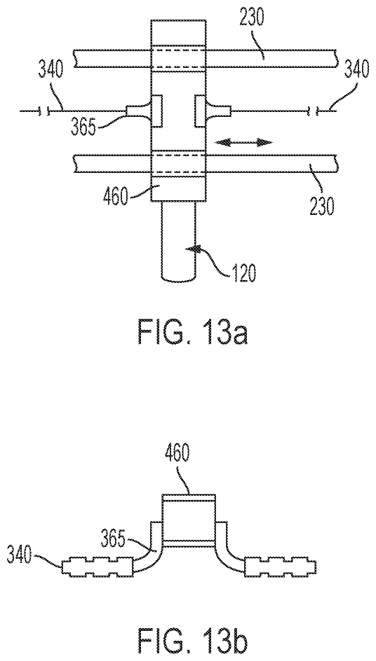

FIGS. 13a and 13b provide additional views from a top view of an embodiment of the main cutter housing according to the invention. More specifically, the chain linkages 340 are shown with the bracket offset and cog 350, which moves the cutting apparatus 120/125 along each horizontal track, thereby moving the cutting instrument along the width of the cutting aperture. The U-channels or C-channels 220 provide mechanisms for the movement of the traveler in a vertical direction when adjustment is needed.

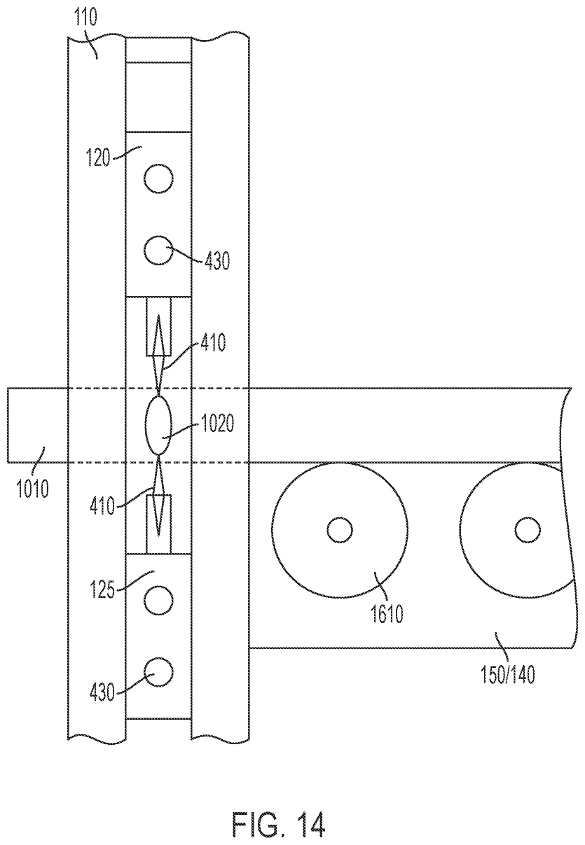

FIG. 14 provides a close-up side view of a portion of an alternative embodiment of the invention having rollers 1610 where a workpiece 1010 is engaged by two cutting blades 410 at a cutting region 1020. The bed/table 140/150 that supports object workpieces are preferably set up 1˜2 mm lower where the tip of the blade of the bottom cutting apparatus 125 is to be provided. This ensures that when the blade slides on its tracks, it is 1˜2 mm into the bottom of the sheetrock, scoring the bottom side paper. The upper apparatus 120 has an adjustment mechanism 180 to allow for the right thickness of sheetrock being cut. The workpiece 1010 is shown partially through the aperture where the top and bottom cutting apparatus 120/125 are shown with their associated cutting blades 410 intersecting the plane of the workpiece at a cutting region 1020 in a manner to cut the workpiece. The cutting region is adjustable for the intended workpiece. For example, for sheetrock, although not to scale, the depth of cut of the blade workpiece plane shown is preferably only sufficient to ensure complete cutting of a top paper surface of a sheetrock workpiece. In FIG. 10, an alternative embodiment of the left side bed, right side bed, and back bed are provided as frames having rollers 1610 that is rotatably attached to the inside surfaces of each bed frame. The rollers can be aligned for ease of movement of the workpiece through the cutting aperture.

FIG. 15 shows a perspective view of an alternative embodiment of the invention, wherein each of the left side beds, right side bed, and back side bed are provided as frames having rollers 1610 that are rotatably connected within each of the frames. The rollers are preferably disposed to promote the movement of a workpiece toward and away from the cutting aperture.

In a further alternative embodiment, such as that one may desire for use at a staging area of a construction site, where a larger embodiment can be provided, the portable cutting can include an electromechanical cutting apparatus controller, such as including a motor 375 and electric/electronic controller 378 which can set the desired length of the sheet rock to be cut, and include a communications connection 379 such as a Wi-Fi phone or radio device to receive can remote commands and data, and application-specific computer for receiving multiple orders from remote workers who may use a portable communications device to provide instructions and data, such as measurements of a requested workpiece at another area of the job site to the cutting device at the staging area of the job site.

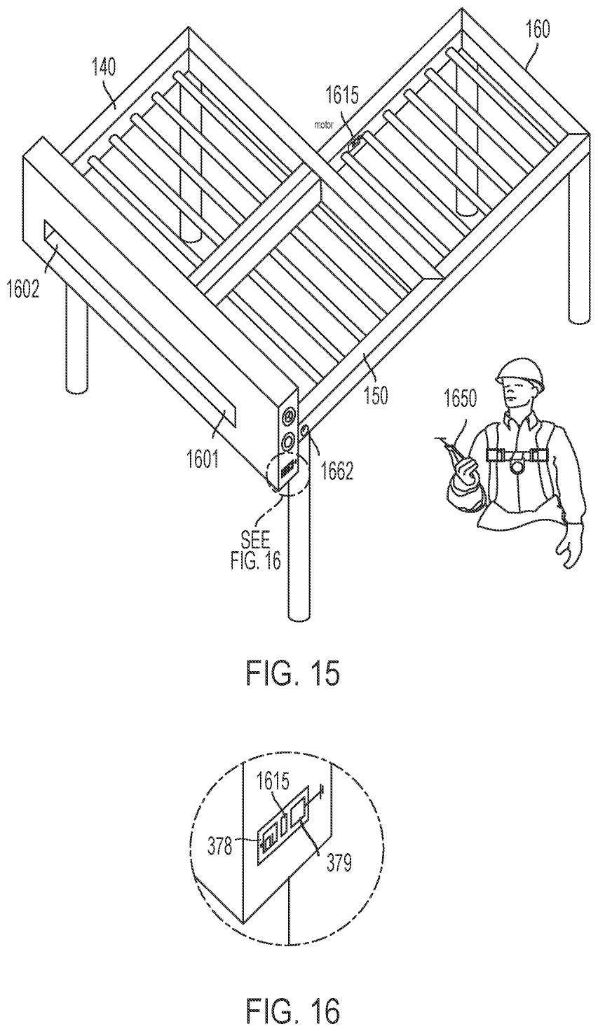

In the alternative embodiment, the electric motor is operably connected to the upper cutting apparatus, and the processor 378 is programmed and adapted for user input to engage the electric motor to engage or start the cutting apparatus across a width of the aperture, one or more times, as the device may be programmed. When additional workpieces are desired to be cut, the processor 378 may instruct a bedframe controller 1615 to engage a motor to move the rollers, such as shown in FIG. 16, on one or more of the bed frames and allow a further workpiece to be moved to the aperture for cutting. The processor 378 communicates with the bedframe controller, which is operatively connected to a length sensor 1662, such as an infrared LED, provided at a side portion of one or more of the left bed, right bed, and back bed. The length sensor provides sensor data to the processor 378 for measuring the length of a workpiece that may be requested by a user from a remote location device 1650.

In addition, the processor is programmed and adapted for user input to provide a cutting thickness and to electronically adjust the position of the upper 230 horizontal track along a height of the aperture for a particular workpiece.

In a further alternative embodiment, a resistance sensor 379 is provided for the prime mover to sense the resistance of the knife blade pressure during the cutting operation and provide an alert when the pressure or resistance reaches a predetermined threshold, which can be used to signal an operator to change the cutting blades.

As shown in FIG. 16, the cutting apparatus includes a communications connection 1615 to receive information from remote job assistant devices 1650, including remote commands and data, such as job numbers, and job measurements, among other things. It can be appreciated by a person of ordinary skill in the art that the remote job assistant device 1650 can be provided as software integrated in a handheld electronic device such as an “app” or application software that receives commands and data, such as job numbers, and job measurements, among other things for a user to input and transmit to the communication connection 1615 of the cutting apparatus.

In one embodiment, an electronic cutting apparatus controller is provided as an application-specific integrated circuit or computer that is programmed or adapted for receiving one or more orders from remote workers who provide measurements at another area of the job site to the portal cutting device. An operator at the cutting device, which can be provided at the staging area of the job site, can review the remote orders and engage the cutting device for a cutting operation. Communications can be provided through Wi-Fi or a similar local communication system (FCC approved), and the cutting device operator's terminal or control panel is adapted to receive and store the remote requests. Accordingly, it is the intention of the instant invention to provide an efficient, lightweight cutting device to enable construction with savings of time and avoided waste material.

Throughout the disclosure, vertical, horizontal, left, right, top and bottom are provided for reference of illustration and are not to scale.

Where a range of values is provided, every intervening value between the upper and lower limit of that range and any other stated or intervening value in that stated range is included within the invention. The upper and lower limits of these smaller ranges may be included in the smaller ranges and are likewise included within the invention. Where the stated range includes one or both of the limits, ranges excluding either or both of those included limits are also included in the invention

In this specification and in the appended claims, the singular forms “a”, “and”, “said”, and “the” include plural referents unless the context clearly dictates otherwise. The claims may be so-drafted to require singular elements or exclude any optional element. These statements provide an antecedent basis for the use of such exclusive terminology as “solely”, “only”, and the like in connection with the recitation of claim elements and/or the use of “negative” claim limitation(s).

While this invention has been described in conjunction with the exemplary embodiments outlined above, the foregoing description of exemplary embodiments of the invention, as set forth above, is illustrative, not limiting. The invention is not necessarily so constrained. Many alternatives, adaptations, modifications, and/or variations may be apparent to those skilled in the art. Various changes may be made to the system and process embodying the principles of the invention. The foregoing embodiments are set forth in an illustrative and not in a limiting sense. The scope of the invention is defined by the claims appended hereto.

1. A portable cutting device to cut a workpiece comprising:
a main cutter housing,
upper cutting apparatus
bottom cutting apparatus
a cutting apparatus controller
a left side bed,
a right side bed, and
a back side bed,
wherein
the main cutter housing comprises a first horizontal track, a second horizontal track, a right-side vertical track, a left-side vertical track and a workpiece aperture wherein said upper horizontal track is disposed on a top side of the main cutter housing and is movably connected a top end of the right-side vertical track in a vertical direction, and includes at least one upper cutting apparatus movably disposed therein to move along said first horizontal track in a horizontal direction, and wherein said bottom horizontal track is disposed on a bottom side of the main cutter housing and includes at least one bottom cutting apparatus movably disposed thereon to move along said second horizontal track, wherein said upper horizontal track and bottom horizontal track are parallel to one another and whereby said upper cutting apparatus and said bottom cutting apparatus are disposed within at least a portion of said workpiece aperture to simultaneously and horizontally traverse the aperture to thereby cut a top side and a bottom side of a workpiece simultaneously upon activation of the cutting apparatus controller.

2. The portable cutting device according to claim 1 wherein the cutting apparatus further comprises a removeable drywall cutting blade.

3. The portable cutting device according to claim 1 wherein the cutting apparatus further comprises a removeable circular cutting blade.

4. The portable cutting device according to claim 1 wherein the cutting apparatus controller includes a manual hand crank and screw operably connected to the upper cutting apparatus whereby manual operation of the hand crank drives the cutting apparatus across a width of the aperture.

5. The portable cutting device according to claim 1 wherein the cutting apparatus controller includes a manual hand crank and screw operably connected to the right-side vertical track and one end of the upper horizontal track whereby manual operation of the hand crank drives the upper horizontal track along a height of the aperture.

6. The portable cutting device according to claim 1 wherein the cutting apparatus controller comprises at least one electric motor operably connected to the upper cutting apparatus, and an electronic processor wherein the electronic processor includes programming and is adapted for a user input to engage the electric motor to drive cutting apparatus across a width of the aperture.

7. The portable cutting device according to claim 1 wherein the cutting apparatus controller comprises at least one electric motor operably connected to the right-side vertical track, and an electronic processor wherein the electronic processor includes programming and is adapted for a user input to provide a cutting thickness, and to electronically adjust a position of the horizontal track along a height of the aperture.

8. The portable cutting device according to claim 1, wherein said left side bed is rectangular and removably connected to a first side of said workpiece aperture and disposed orthogonal to said main cutter housing, wherein said right side bed is rectangular and removably connected to said first side of said workpiece aperture and disposed orthogonal to said main cutter housing, and wherein said back side bed is rectangular and removably connected to at least one of a left side bed and a right side bed.

9. The portable cutting device according to claim 1, wherein said bottom horizontal track is movably connected a bottom end of the right-side vertical track in a vertical direction.

10. The portable cutting device according to claim 1, wherein said upper cutting apparatus and bottom cutting apparatus each include a housing and at least one spring, wherein said spring is operably connected to a portion of the cutting apparatus to provide a compressive resistance against said cutting apparatus, and said housing contains at least a portion of said spring and said cutting apparatus to constrain a portion of movement of said cutting apparatus within said housing.

11. The portable cutting device according to claim 1 wherein said cutting apparatus is adapted for receiving a plurality of cutting instrument types.

12. The portable cutting device according to claim 6 further comprising a remote location device 1650, and wherein the electronic processor includes programming adapted for a user input to from a remote job assistant device to engage the electric motor to drive cutting apparatus across a width of the aperture.
